(19) United States
(12) Patent Application Publication
(10) Pub. No.: US 2024/0018728 A1
(43) Pub. Date: Jan. 18, 2024

(54) APPARATUS AND METHOD FOR DRYING MATERIAL AND ASPHALT MIXING FACILITY COMPRISING SUCH AN APPARATUS

(71) Applicant: Benninghoven Zweigniederlassung der Wirtgen Mineral Technologies GmbH, Wittlich (DE)

(72) Inventors: Marius KLOFT, Wittlich (DE); Steven MACNELLY, Büchel (DE); Daniel SIEBRECHT, Zeltingen-Rachtig (DE); Matthias Walter JOHANN, Bad Bertrich (DE)

(21) Appl. No.: 18/351,445

(22) Filed: Jul. 12, 2023

(30) Foreign Application Priority Data
Jul. 14, 2022 (DE) 10 2022 207 220.0

(51) Int. Cl. E01C 19/05; E01C 19/10

(52) U.S. Cl. CPC E01C 19/05; E01C 19/10

(57) ABSTRACT

An apparatus for drying material for an asphalt mixing facility comprising a fan for generating an air flow, a heating unit that is fluidically connected to the fan for heating the air flow, and at least one drying drum that is fluidically connected to the heating unit for drying material by means of the heated air flow, wherein the heating unit can be driven electrically.

### CROSS-REFERENCES TO RELATED APPLICATIONS

This application claims the priority of German Patent Application, Serial No. DE 10 2022 207 220.0, filed Jul. 14, 2022, the content of which is incorporated herein by reference in its entirety as if fully set forth herein.

### FIELD

The disclosure relates to an apparatus and a method for drying material and to an asphalt mixing facility comprising such an apparatus to carry out such a method.

In an asphalt mixing facility, different materials are processed, in particular dried and mixed together. Drying takes place in a drying drum. The drying drum is supplied with heat that has previously been generated by means of a separate heating unit. The heat generation is based on the combustion of fossil energy sources, such as natural gas, liquid gas, fuel oil and/or coal dust. The combustion of fossil energy sources produces pollutants, in particular CO₂, SO₂ and NO_{X}, which are problematic with regard to the climate.

### SUMMARY

It is an object of the disclosure to make the drying of material for an asphalt mixing facility more efficient and/or ecologically advantageous and, in particular, climate-friendly.

This object is achieved by an apparatus for drying material for an asphalt mixing facility, wherein the apparatus comprises a fan for generating an air flow, a heating unit that is connected fluidically to the fan for heating the air flow, and at least one drying drum that is connected fluidically to the heating unit for drying material by means of the heated air flow, wherein the heating unit can be driven electrically.

It has been recognized that material is dried in an ecologically advantageous and climate-friendly manner, in particular, if an air flow that is used for drying the material is heated by means of electrical energy. Advantageously, the electrical energy is obtained from renewable energy sources.

According to one embodiment, a heating unit is operated with electric current. In the heating unit, electrical energy is converted into heat. The heating unit is used to heat the air flow to form a hot gas flow, which can then be fed to at least one drying drum. Advantageously, the heating unit has a modular design with a plurality of interconnected heating coils. This makes the heating unit and its heating power easily scalable. In particular, the heating unit has a heating capacity L_{H}, wherein in particular L_{H}≥5 MW in particular L_{H}≥10 MW, in particular L_{H}≥15 MW, advantageously L_{H}≥20 MW.

To generate the air flow, the apparatus has a fan that is fluidically connected to the heating unit. Advantageously, the apparatus has a pipe system comprising several pipes for the fluidic connection of the fan, the heating unit and the at least one drying drum. The pipe system thus serves to guide and distribute the generated air flow to the individual components within the apparatus. In particular, the pipe system serves to feed fresh air into the fan and to feed the air flow that is generated by means of the fan into the heating unit as well as to feed the generated hot gas flow into the drying drum. In other words, the fan is fluidically connected to the heating unit and the heating unit is fluidically connected to the at least one drying drum via the pipe system. Advantageously, the pipe system also has further pipes, in particular for discharging the hot gas flow from the drying drum.

The hot gas flow serves to heat and/or dry the material in the at least one drying drum. In particular, the material can be recycled building material, so-called RC material, and/or white mineral.

The heating unit is designed as an independent unit, in particular separate from the drying drum. This has the advantage that a drying drum according to one embodiment has a higher useful volume, in particular because, in contrast to drying drums with a built-in burner, there is no flame region. Consequently, the drying drum according to one embodiment has a higher number of internals, including, for example, corresponding baffle plates and/or lifter plates. This ensures better mixing and more efficient drying of the material. The heating unit can be located at a distance from and/or to be independent of the drying drum and allows, in particular, an increased flexibility with regard to the utilization of the required space.

No emissions are produced when the air is heated. CO, CO₂ and/or NO_{X} emissions, which typically occur during combustion, are avoided. The apparatus is ecologically advantageous and in particular climate-friendly. Due to the electrical heating of the air flow, the emissions of the drying drum essentially, in particular exclusively, comprise water vapour, air and dust, as well as emissions from the material to be heated, for example recycled material or greywacke. The proportion of environmentally harmful pollutants, such as SO₂, and/or similar volatile organic compounds (VOC), in the exhaust gas from the drying drum, which is produced by heating the material, is reduced and is in particular at most 5% by volume, in particular at most 3% by volume, in particular at most 1% by volume and in particular at most 0.1% by volume.

Advantageously, the apparatus with the electrically driven heating unit does not fall under regulations for keeping the air clean, in particular under the “Technical Instructions on Air Quality Control” or “TA Luft” for short, since no combustion process takes place when the air flow is heated.

With the electrically drivable heating unit, lower noise emissions are caused, so that night operation of the apparatus is possible. During night operation, cheaper electricity can be used. Consequently, the operating costs are reduced.

The public power grid is usually designed to be fail-safe. In particular, the apparatus with the electrically drivable heating unit is designed to ensure reliable power supply. Advantageously, the electricity is obtained via the power grid. Transport and/or storage volumes for fossil energy sources are avoided. This eliminates extra costs and/or the risk of a possible shortage of supply of fossil energy sources. Since no fossil energy sources are burned and consequently no CO₂ is produced, CO₂ pricing can be avoided. The operating costs are also reduced.

An apparatus configured such that the apparatus has a plurality of drying drums enables efficient drying of material. In particular, by using a plurality of drying drums, the throughput of the apparatus can be increased. Advantageously, the apparatus has two drying drums. Alternatively, the apparatus may have further drying drums, in particular three or four drying drums. Advantageously, different materials can be dried in different drying drums and in particular independently of each other. For example, a first drying drum can be used for drying white mineral and a second drying drum for drying RC material. In this way, the respective materials can be selectively heated to different temperatures in the respective drying drum. In other words, with a plurality of drying drums, whereby each drying drum is assigned exactly one material, an individual drying process can be carried out for each of these materials. Thus, a separate adjustment of the drying processes is possible depending on the material to be dried in the respective drying drum.

An apparatus configured such that the heating unit and the plurality of drying drums are fluidically connected in such a manner that the heated air flow can be fed to the drying drums in parallel enables a particularly efficient drying of material as the hot gas flow is supplied to the plurality of drying drums in parallel. In other words, the drying drums are operated in parallel with respect to the hot gas flow and a portion of the generated hot gas flow is supplied to each drying drum. Advantageously, further fans for maintaining the hot gas flow are arranged in the pipe system, in particular downstream of the respective drying drum, in particular along a recirculation duct and/or along an exhaust air duct. Flow guiding elements, in particular flaps, and/or further fans can be arranged to control the air flow within the pipe system.

An apparatus comprising a dust extraction unit for removing dust from the air flow that flows out of the at least one drying drum is ecologically advantageous and efficient. Advantageously, the dust extraction unit is arranged directly downstream of the at least one drying drum. In particular, the dust extraction unit is fluidically connected to the at least one drying drum via the pipe system. The dust extraction unit serves for dust extraction from a cooled hot gas flow that is discharged from the drying drum. Advantageously, the dust contained in the cooled hot gas flow can be extracted via the dust extraction unit, so that purified exhaust gas, in particular clean gas, can be discharged from the dust extraction unit. When a plurality of drying drums are used, the apparatus advantageously has exactly one dust extraction unit, which reduces the energy consumption of the apparatus. Alternatively, when a plurality of drying drums are used, the apparatus can have multiple dust extraction units, wherein in particular one dust extraction unit is assigned to each drying drum and these are each connected fluidically via the pipe system. As a result, targeted dust extraction is achieved when the drying drums are used for different materials in each case.

An apparatus comprising a heat recovery unit for preheating the air flow that is fed to the heating unit is designed to be particularly efficient and ecologically advantageous. The heat recovery unit serves to recover the residual heat of the cooled hot gas flow. In particular, the heat recovery unit is arranged downstream of the dust extraction unit and is fluidically connected thereto via the pipe system. In other words, the cooled hot gas flow that is discharged from the dust extraction unit and its residual heat can be fed to the heat recovery unit via the pipe system. In particular, only clean gas is fed to the heat recovery unit. Preferably, energy that is recovered via the heat recovery unit can be used to preheat an air flow that is fed to the heating unit. Advantageously, the pipe system has a second feed pipe for feeding an air flow that has already been partially heated or preheated by means of the heat recovery unit into the heating unit. In particular, the second feed pipe has its own fan. This increases the efficiency of the apparatus. The heat recovery unit can also be used to separate condensate.

An apparatus comprising a control unit for controlling the heating unit is particularly efficient. Preferably, the control unit serves for stepless control and regulation of the heating unit. Stepless control and regulation is understood to mean that the power of the heating unit can be controlled and regulated as desired between a minimum and a maximum value. In other words, it is possible to set the control unit to any value within a power range between 0% and 100%. The target temperature to be set for the hot gas flow can be flexibly defined and, in particular, dynamically changed. The stepless control and regulation is carried out in particular by stepless adjustment of the electrical power that is supplied to the heating unit.

According to an alternative embodiment, the control unit can have predefined stages for control, whereby the control unit can be adjusted at defined intervals in the aforementioned power range. In the event that the heating unit is formed by a plurality of interconnected heating coils, the respective individual heating coils can advantageously be controlled by means of the control unit and can thus be individually controlled and regulated as well as switched on and off.

An apparatus comprising a switchgear for supplying the heating unit with electrical energy and configured such that the switchgear comprises a transformer for a connection to a voltage network is particularly advantageous because the apparatus can be connected directly to a general voltage network. The general voltage network is in particular a locally available electricity network which is operated in particular with medium voltage or with high voltage. The transformer serves to convert the high voltage of the high voltage network into a medium and/or low voltage to be used for the switchgear and thus to supply the heating unit with electrical energy depending on the power requirement.

The mentioned object is further achieved by an asphalt mixing facility having an apparatus according to the description above, comprising a discharge pipe for discharging the air flow to an exhaust air separation unit.

Advantageously, the discharge pipe is part of the pipe system and serves to discharge an exhaust air flow from the heat recovery unit to an exhaust air separation unit. The exhaust air separation unit is preferably designed as a stack and serves to discharge the air flow or the exhaust air flow to the environment. Preferably, the exhaust air separation unit has filters to filter the exhaust air. In particular, the discharge pipe may have its own fan to maintain the exhaust air flow. In particular, the asphalt mixing facility may also be further embodied by the features indicated above. The advantages of the asphalt mixing facility according to one embodiment correspond to the advantages of the apparatus already described. As a result of the advantages already described, the asphalt mixing facility for drying material is efficient and ecologically advantageous and, in particular, climate-friendly.

The said object is further achieved by a method for drying material for an asphalt mixing facility comprising the method steps of feeding an air flow into a heating unit, heating the air flow in the heating unit by means of electrical energy, and feeding the heated air flow into at least one drying drum for drying material. In particular, the method can also be further embodied by the features indicated above. The advantages of the method according to one embodiment correspond to the advantages of the apparatus or asphalt mixing facility already described. The advantages already described result in the method for drying material being efficient and ecologically advantageous and, in particular, climate-friendly.

A method in which the air flow that is fed to the at least one drying drum has an average drying temperature T_{T}, wherein T_{T}=600° C., is advantageous in terms of ecology and climate protection, since the hot gas flow that is fed to the drying drum has an average drying temperature T_{T}, wherein in particular 400° C.≤T_{T}≤800° C., in particular 500° C.≤T_{T}≤700° C. and in particular T_{T}=600° C. In contrast, the air flow of prior art apparatuses for drying asphalt material by combusting fossil energy sources has a much higher drying temperature. The exhaust gas temperature of a fossil fuel burner is typically between 800° C. and 1200° C. Thus, the apparatus works very efficiently.

A method in which the air flow flows through the apparatus at a standard volume flow V_{V}, wherein V_{V}≥45,000 m³/h, is efficient because the air flow flows through the apparatus at a standard volume flow V_{V}, wherein in particular V_{V}≥45,000 m³/h, in particular V_{V}≥60,000 m³/h, in particular V_{V}≥75,000 m³/h, in particular V_{V}≥90,000 m³/h and in particular V_{V}≥100,000 m³/h. Due to the higher volume flow, a high amount of energy can be transported, in particular despite the comparatively lower drying temperature. It has been recognized that the standard volume flow depends on the electrical power of the heater. In particular, the standard volume flow is at least 45,000 m³/h for an electrical power of 10 MW and at least 90,000 m³/h for an electrical power of 20 MW. In contrast, the air flow of prior art apparatuses for drying asphalt material by combusting fossil energy sources has a much lower standard volume flow within the apparatus.

A method in which the air flow in the at least one drying drum has a standard volume flow V_{T}, wherein V_{T}≥90,000 m³/h, is efficient because the hot gas flow in the drying drum has a standard volume flow V_{T}, wherein in particular V_{T}≥80,000 m³/h, in particular V_{T}≥85,000 m³/h, in particular V_{T}≥90,000 m³/h. In contrast, the air flow of prior art apparatuses for drying asphalt material by combusting fossil energy sources has a much lower standard volume flow within the drying drum. It has been found that moisture, in particular water and/or water vapour, escaping from the RC material to be dried can be absorbed in the drying drum.

Further features, advantages and details of the disclosure will be apparent from the following description of an embodiment.

### BRIEF DESCRIPTION OF THE DRAWING

FIG. 1 is a schematic illustration of an asphalt mixing facility with an apparatus according to one embodiment.

### DETAILED DESCRIPTION

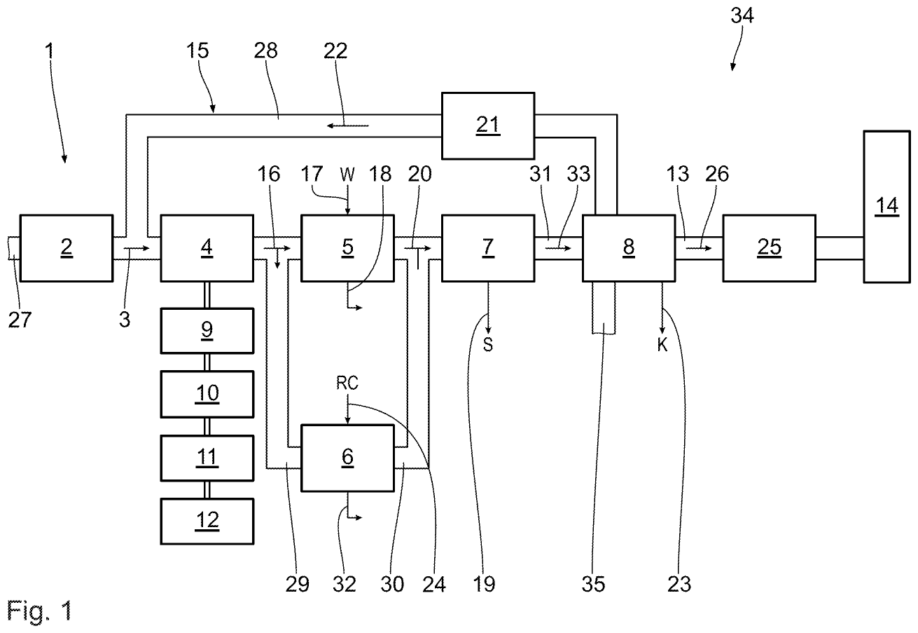

FIG. 1 is a schematic illustration of an asphalt mixing facility 34 with an apparatus 1 for drying material. The apparatus 1 comprises a heating unit 4, a first drying drum 5 and a second drying drum 6 as well as a pipe system 15.

The pipe system 15 comprises a plurality of pipes for the fluidic connection of the individual components of the apparatus 1. A first feed pipe 27 is used to feed ambient air into the pipe system 15 of the apparatus 1. In this case, an air flow 3 is generated in the feed pipe 27 via a fan 2, which is fed to the heating unit 4. The ambient air has an average ambient temperature T_{U} of 10° C.

The heating unit 4 can be driven electrically and, according to the embodiment shown, is formed by a plurality of interconnected heating coils. The heating coils have a total capacity L_{H}, wherein L_{H}=17 MW. The heating unit 4 serves to electrically heat the air flow 3 to form a hot gas flow 16. In doing so, the heating unit 4 heats the fed air flow 3 to form a hot gas flow 16 having an average drying temperature T_{T} of 600° C.

The hot gas flow 16 that is generated in the heating unit 4 is fed in parallel to the two drying drums 5 and 6 via a first connection pipe 29 of the pipe system 15. In other words, both drying drums 5 and 6 are operated in parallel with respect to the hot gas flow 16. The drying drums 5 and 6 serve to dry material by means of convection, wherein the drying drum 5 serves to dry white mineral W and/or RC material and the parallel drying drum 6 serves to dry, in particular separately, RC material. When RC material is heated in the drying drum 5, this is done in particular in a bypass mode to prevent caking of the heated RC material. In the bypass mode, material, in particular white mineral W, can be fed past a sieve that is arranged downstream of the drying drum 5. Alternatively, the white mineral can be fed to a sieve located downstream of the drying drum to sieve out individual fractions. In the bypass mode, the grading curve is set via a pre-dosing, whereas in the sieve mode, a more precise grading curve is produced during mixing, as the individual fractions from the hot mix storage silo can be weighed separately.

Both drying drums 5 and 6 each have a material inlet 17, 24 and a material outlet 18, 32. According to the embodiment shown, the material inlet 17, 24 and the material outlet 18, 32 in each case are arranged opposite each other at the drying drums 5 and 6.

In the course of drying, the respective material is heated and, in particular, dried within the drying drums 5 and 6, wherein the hot gas flow 16 cools down from the average drying temperature T_{T} of 600° C. to a cooled hot gas flow 20 having an average cooling temperature T_{A} of 100° C. The drying drums 5 and 6 are fluidically connected to a dust extraction unit 7 via a second connection pipe 30 of the pipe system 15. The dust extraction unit 7 serves to extract dust from the cooled hot gas flow 20, whereby the cooled hot gas flow 20 can be discharged from the dust extraction unit 7 in the form of clean gas. The dust extraction unit 7 has a dust outlet 19 for discharging the dust S.

A heat recovery unit 8 is arranged downstream of the dust extraction unit 7. The heat recovery unit 8 and the dust extraction unit 7 are fluidically connected to each other via a third connection pipe 31 of the pipe system 15. The heat recovery unit 8 serves to recover the residual heat from the cooled hot gas flow 20. For this purpose, the heat recovery unit 8 has a heat exchanger which preheats drawn-in ambient air and feeds it to the heating unit 4 as a preheated air flow 22 via a second feed pipe 28. A suction port 35 is arranged at the heat recovery unit 8 for sucking in the ambient air. To generate the preheated air flow 22, the second feed pipe 28 has a second fan 21. The heat recovery unit 8 also serves to separate a condensate K, wherein the latter can be discharged from the heat recovery unit 8 via a condensate outlet 23.

The heat recovery unit 8 is connected via a discharge pipe 13 to an exhaust air separation unit 14 in the form of an exhaust air stack, wherein a cooled exhaust air flow 26 that is discharged from the heat recovery unit 8 can be fed to the exhaust air separation unit 14 by means of a further fan 25. This recirculates the cooled exhaust air flow 26 to the environment in the form of clean gas.

The apparatus 1 has a control unit 9. The control unit 9 is used for stepless control and regulation of the heating unit 4. This means that the power of the heating unit 4 can be controlled or regulated as desired between a minimum and a maximum value. By means of the control unit 9, it is possible to control the heating coils of the heating unit 4 individually, whereby they can be individually controlled and regulated or switched on and off.

The apparatus 1 is connected to a voltage network 12 by means of a switchgear and a transformer 11. The transformer 11 serves to convert a high voltage of the voltage network 12 into a medium and/or low voltage for use by the switchgear 10 and thus to supply the heating unit 4 with electrical energy.

The method for drying material by means of an apparatus 1 for an asphalt mixing facility 34 is as follows:

An air flow 3 is fed to the heating unit 4 by means of the fan 2 via a first feed pipe 27 and/or a preheated air flow 22 is fed by means of the fan 21 via a second feed pipe 28. The air flow 3 that is fed to the heating unit 4 has an average ambient temperature T_{U} of about 10° C. auf and can be greater if the air flow 22 is preheated accordingly. In this case, the supplied air flow 3 can have a temperature of up to 50° C. or more.

In the heating unit 4, the air flow 3 is electrically heated to form a hot gas flow 16 having an average drying temperature T_{T} of 600° C. The hot gas flow 16 that is discharged from the heating unit 4 is fed in parallel to the two drying drums 5 and 6 via the first connection pipe 29. In the course of drying the materials inside the drying drums 5 and 6, the hot gas flow 16 is cooled down from the average drying temperature T_{T} of 600° C. to a cooled hot gas flow 20 having an average cooling temperature T_{A} of 100° C. The cooled hot gas flow 20 is fed via the second connection pipe 30 to the dust extraction unit 7 where dust is extracted. The cooled and de-dusted hot gas flow 33 is then discharged from the dust extraction unit 7 in the form of clean gas and fed to the heat recovery unit 8 via the third connection pipe 31. The average cooling temperature T_{A} remains unchanged during dust extraction. By means of the heat recovery unit 8, the residual heat of the average cooling temperature T_{A} of 100° C. is used to preheat the preheated air flow 22 that is fed to the heating unit 4 via the second feed pipe 28. The exhaust air flow 26 that is discharged from the heat recovery unit 8 is then recirculated to the environment via a discharge pipe 13 by means of the exhaust air separation unit 14.

During the operation of the asphalt mixing facility 34, the air flow passes through the apparatus at a standard volume flow V₁, wherein V₁≥75,000 m³/h. In addition, the hot gas flow that is fed to the drying drum has a standard volume flow V₂ auf, wherein V₂≥90,000 m³/h.

What is claimed is:

1. An apparatus for drying material for an asphalt mixing facility, the apparatus comprising:
a fan for generating an air flow;
a heating unit in fluid communication with the fan for heating the air flow; and
at least one drying drum in fluid communication with the heating unit for drying material via heated air flow,
wherein the heating unit is configured to be driven electrically.

2. The apparatus according to claim 1, wherein the at least one drying drum is a plurality of drying drums.

3. The apparatus according to claim 2, wherein the heating unit and the plurality of drying drums are in fluid communication such that heated air flow can be fed to the drying drums in a parallel manner.

4. The apparatus according to claim 1, further including a dust extraction unit for removing dust from air out of the at least one drying drum.

5. The apparatus according to claim 1, further including a heat recovery unit for preheating air fed to the heating unit.

6. The apparatus according to claim 1, further including a control unit for controlling the heating unit.

7. The apparatus according to claim 1, further including a switchgear for supplying the heating unit with electrical energy.

8. The apparatus according to claim 7, wherein the switchgear includes a transformer for a connection to a voltage network.

9. An asphalt mixing facility having the apparatus according to claim 1 and including a discharge pipe for discharging air flow to an exhaust air separation unit.

10. A method for drying material for an asphalt mixing facility, the method comprising:
feeding air into a heating unit;
heating air in the heating unit via electrical energy; and
feeding heated air into at least one drying drum.

11. The method according to claim 10, wherein the heated air fed to the at least one drying drum has an average drying temperature of 600° C.

12. The method according to claim 10, wherein air flows in the heating unit at a standard volume flow greater than or equal to 45,000 m³/h.

13. The method according to claim 10, wherein air flows in the at least one drying drum at a standard volume flow greater than or equal to 90,000 m³/h.

14. The method according to claim 10, further including discharging air from the drying drum into a dust extraction unit.

15. The method according to claim 10, further including preheating air fed to the heating unit by a heat recovery unit.
